(19) United States
(12) Patent Application Publication
(10) Pub. No.: US 2026/0353356 A1
(43) Pub. Date: Nov. 5, 2026

(54) METHOD AND APPARATUS FOR TRANSMITTING/RECEIVING WIRELESS SIGNAL IN WIRELESS COMMUNICATION SYSTEM

(71) Applicant: LG Electronics Inc., Seoul (KR)

(72) Inventors: Seunggye HWANG, Seoul (KR); Seonwook KIM, Seoul (KR); Youngdae LEE, Seoul (KR); Suckchel YANG, Seoul (KR); Sechang MYUNG, Seoul (KR)

(21) Appl. No.: 19/112,446

(22) PCT Filed: Oct. 11, 2023
(86) PCT No.: PCT/KR2023/015612

§ 371 Date: Mar. 17, 2025

Related U.S. Application Data
(60) Provisional application No. 63/415,274, filed on Oct. 11, 2022.

(51) Int. Cl. H04W 68/02; H04L 5/00; H04W 76/28

(52) U.S. Cl. CPC H04W 68/02; H04L 5/0044; H04W 76/28

(57) ABSTRACT

A method by which a terminal receives a signal in a wireless communication system, according to one embodiment of the present disclosure, comprises: receiving a network energy saving (NES)-related configuration from a network; and monitoring a paging signal in at least one paging time resource determined on the basis of the NES-related configuration from among a plurality of paging time resources related to paging discontinuous reception (DRX), wherein the NES-related configuration includes information about NES paging windows provided while an NES operation is performed and, while the NES operation is performed, the terminal can monitor the paging signal on the basis of some paging time resources that exclude paging time resources located outside of the NES paging windows.

### TECHNICAL FIELD

The present disclosure relates to a wireless communication system, and more particularly, to a method and apparatus for transmitting and receiving a wireless signal.

### BACKGROUND

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may be any of a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### DISCLOSURE

### Technical Problem

An object of the present disclosure is to provide a method and apparatus for efficiently performing a wireless signal transmission/reception procedure.

Other technical objects may be derived from embodiments disclosed in the detailed description.

### Technical Solution

According to an aspect, a method of receiving a signal by a user equipment (UE) in a wireless communication system includes receiving a network energy saving (NES) related configuration from a network, and monitoring a paging signal in at least one paging time resource determined based on the NES related configuration from among a plurality of paging time resources related to paging discontinuous reception (DRX). The NES related configuration may include information about NES paging windows provided while an NES operation is performed. While the NES operation is performed, the UE may perform monitoring of the paging signal based on a part of the paging time resources excluding paging time resources located outside the NES paging windows.

The information about the NES paging windows may include at least one of information about a period of the NES paging windows and information about a length of each NES paging window.

The information about the NES paging windows may include information about a pattern of the NES paging windows in the time domain.

From among the paging time resources included in the first NES paging window, monitoring of the paging signal may be performed on an Nth paging time resource, and from among the paging time resources included in the second NES paging window, monitoring of the paging signal may be performed on the Mth paging time resource, and N and M may be different integers.

The Nth paging time resource in the first NES paging window and the Mth paging time resource in the second NES paging window may be determined through a paging time resource hopping rule defined in the time domain.

The NES related configuration may include information about the paging time resource hopping rule.

The monitoring of the paging signal may be omitted on paging time resources between the first NES paging window and the second NES paging window.

The NES related configuration may be for an NES operation in a radio resource control (RRC) idle/inactive state.

Each paging time resource may be either a paging frame (PF) or a paging occasion (PO).

The paging signal may be a physical downlink control channel (PDCCH) with a cyclic redundancy check (CRC) scrambled with a paging-radio network temporary identifier (P-RNTI).

According to another aspect, a computer-readable recording medium having recorded thereon a program for performing the signal receiving method described above may be provided.

According to another aspect, a UE performing the signal receiving method described above may be provided.

According to another aspect, a signal processing device for controlling a UE performing the signal receiving method described above may be provided.

According to another aspect, a method of transmitting a signal a base station (BS) in a wireless communication system includes transmitting a network energy saving (NES) related configuration, and transmitting a paging signal in at least one paging time resource determined based on the NES related configuration from among a plurality of paging time resources related to paging discontinuous reception (DRX). The NES related configuration may include information about NES paging windows provided while an NES operation is performed. While the NES operation is performed, the BS may perform transmission of the paging signal based on a part of the paging time resources excluding paging time resources located outside the NES paging windows.

According to another aspect, a BS performing the signal transmitting method described above may be provided.

### Advantageous Effects

According to an embodiment, a signal may be transmitted/received more accurately and more efficiently in a wireless communication system.

Other technical effects may be derived from embodiments disclosed in the detailed description.

### BRIEF DESCRIPTION OF THE DRAWINGS

FIG. 1 illustrates physical channels used in a 3rd generation partnership project (3GPP) system as an exemplary wireless communication system, and a general signal transmission method using the same.

FIG. 2 illustrates a radio frame structure.

FIG. 3 illustrates a resource grid of a slot.

FIG. 4 illustrates exemplary mapping of physical channels in a slot.

FIG. 5 illustrates an exemplary physical downlink control channel (PDCCH) transmission and reception process.

FIG. 6 illustrates an exemplary physical downlink shared channel (PDSCH) reception and acknowledgement/negative acknowledgement (ACK/NACK) transmission process.

FIG. 7 illustrates an exemplary physical uplink shared channel (PUSCH) transmission process.

FIGS. 8 to 10 are diagrams illustrating a DRX-related operation.

FIG. 11 is a diagram illustrating a WUS.

FIG. 12 is a diagram for explaining a method of providing a separate paging DRX cycle for a network energy saving (NES) user equipment (UE) according to an embodiment.

FIG. 13 is a diagram for explaining a method of signaling a total number of paging frames (PFs) within a paging discontinuous reception (DRX) cycle to a NES UE according to an embodiment.

FIG. 14 is a diagram for explaining signaling of paging frame (PF)/paging occasion (PO) skipping related information of an NES UE according to an embodiment.

FIG. 15 is a diagram for explaining periodic hopping of a location of a PF/PO of an NES UE according to an embodiment.

FIG. 16 is a diagram for explaining signaling of information of a PO burst per PF for an NES UE according to an embodiment.

FIG. 17 is a diagram for explaining distributing UE IDs to POs configured within a PO burst according to an embodiment.

FIG. 18 is a diagram for explaining signal reception of a UE according to an embodiment.

FIG. 19 is a diagram for explaining signal transmission of a BS according to an embodiment.

FIGS. 20 to 23 illustrate an example of a communication system 1 and wireless devices applicable to the present disclosure.

### DETAILED DESCRIPTION

Embodiments of the present disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for

GSM Evolution (EDGE). OFDMA may be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive Machine Type Communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and Ultra-Reliable and Low Latency

Communication (URLLC) is being discussed. In an embodiment of the present disclosure, for simplicity, this technology will be referred to as NR (New Radio or New RAT).

For the sake of clarity, 3GPP NR is mainly described, but the technical idea of the present disclosure is not limited thereto.

For the background art relevant to the present disclosure, the definitions of terms, and abbreviations, the following documents may be incorporated by reference.

### 3GPP LTE

38.211: Physical channels and modulation
38.212: Multiplexing and channel coding
38.213: Physical layer procedures for control
38.214: Physical layer procedures for data
38.215: Physical layer measurements
38.300: NR and NG-RAN Overall Description
38.304: User Equipment (UE) procedures in idle mode and in RRC Inactive state
38.321 Medium Access Control (MAC) protocol specification
38.331: Radio Resource Control (RRC) protocol specification
37.213: Introduction of channel access procedures to unlicensed spectrum for NR-based access
36.355: LTE Positioning Protocol
37.355: LTE Positioning Protocol

### Terms and Abbreviations

5GC: 5G Core Network
5GS: 5G System
AP: Access Point
CID: Cell ID
E-CID: Enhanced Cell ID
PRS: Positioning Reference Signal
RRM: Radio Resource Management
TP: Transmission Point
TRP: Transmission and Reception Point
UE: User Equipment
SSB: Synchronization Signal Block
SFN: System Frame Number
SS: Search Space
CSS: Common Search Space
USS: UE-specific Search Space
PDCCH: Physical Downlink Control Channel
PDSCH: Physical Downlink Shared Channel;
PUCCH: Physical Uplink Control Channel;
PUSCH: Physical Uplink Shared Channel;
DCI: Downlink Control Information
UCI: Uplink Control Information
SI: System Information
SIB: System Information Block
MIB: Master Information Block
RRC: Radio Resource Control
DRX: Discontinuous Reception
RNTI: Radio Network Temporary Identifier
CSI: Channel state information
PCell: Primary Cell
SCell: Secondary Cell
PSCell: Primary SCG (Secondary Cell Group) Cell
CA: Carrier Aggregation
WUS: Wake up Signal
PF: Paging Frame
PO: Paging Occasion
PEI: Paging Early Indication
PEI-O: PEI Occasion
NES: Network Energy Saving
RO: RACH Occasion
RAR: Random Access Response
SDT: Small Data Transmission

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

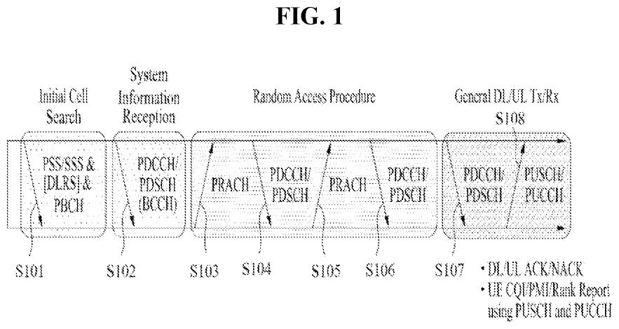

FIG. 1 illustrates physical channels used in a 3GPP NR system and a general signal transmission method using the same.

When a UE is powered on again from a power-off state or enters a new cell, the UE performs an initial cell search procedure, such as establishment of synchronization with a BS, in step S101. To this end, the UE receives a synchronization signal block (SSB) from the BS. The SSB includes a primary synchronization signal (PSS), a secondary synchronization signal (SSS), and a physical broadcast channel (PBCH). The UE establishes synchronization with the BS based on the PSS/SSS and acquires information such as a cell identity (ID). The UE may acquire broadcast information in a cell based on the PBCH. The UE may receive a DL reference signal (RS) in an initial cell search procedure to monitor a DL channel status.

After initial cell search, the UE may acquire more specific system information by receiving a physical downlink control channel (PDCCH) and receiving a physical downlink shared channel (PDSCH) based on information of the PDCCH in step S102.

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

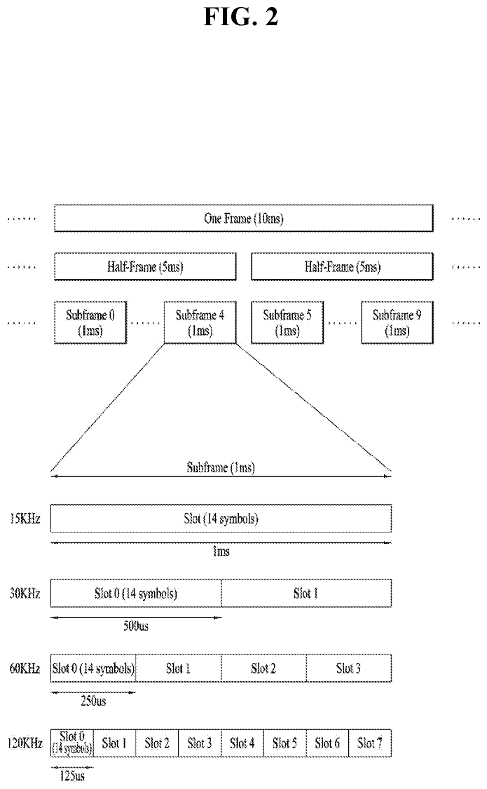

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 Orthogonal Frequency Division Multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15*2^{u}) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

N^{slot}_{symb}: Number of symbols in a slot
N^{frame, u}ₛₗₒₜ: Number of slots in a frame
N^{subframe, u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The structure of the frame is merely an example. The number of subframes, the number of slots, and the number of symbols in a frame may vary.

In the NR system, OFDM numerology (e.g., SCS) may be configured differently for a plurality of cells aggregated for one UE. Accordingly, the (absolute time) duration of a time resource (e.g., an SF, a slot or a TTI) (for simplicity, referred to as a time unit (TU)) consisting of the same number of symbols may be configured differently among the aggregated cells. Here, the symbols may include an OFDM symbol (or a CP-OFDM symbol) and an SC-FDMA symbol (or a discrete Fourier transform-spread-OFDM (DFT-s-OFDM) symbol).

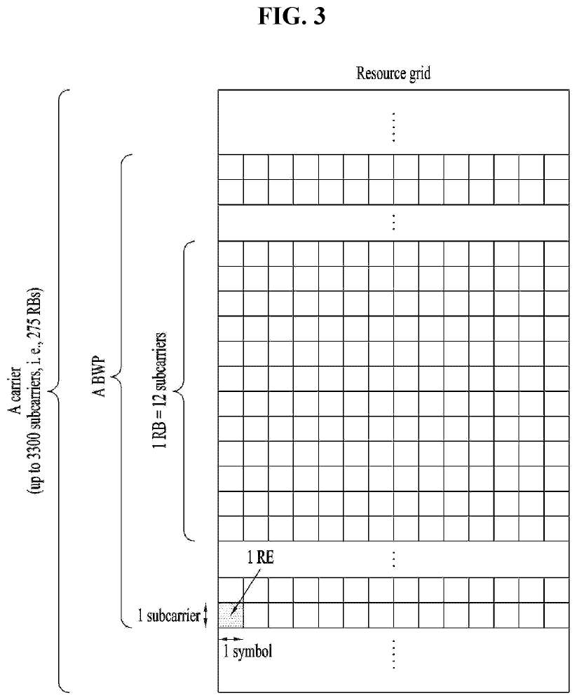

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

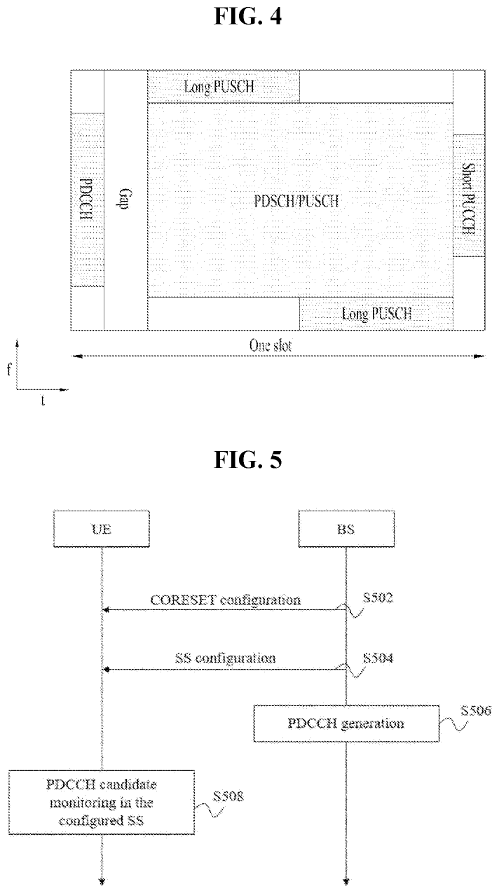

FIG. 4 illustrates an example of mapping physical channels in a slot. In an NR system, a frame is characterized by a self-contained structure in which all of a DL control channel, DL or UL data, and a UL channel may be included in one slot. For example, the first N symbols of a slot may be used to carry a DL channel (e.g., PDCCH) (hereinafter, referred to as a DL control region), and the last M symbols of the slot may be used to carry a UL channel (e.g., PUCCH) (hereinafter, referred to as a UL control region). Each of N and M is an integer equal to or larger than 0. A resource area (hereinafter, referred to as a data region) between the DL control region and the UL control region may be used to transmit DL data (e.g., PDSCH) or UL data (e.g., PUSCH). A guard period (GP) provides a time gap for switching from a transmission mode to a reception mode or from the reception mode to the transmission mode. Some symbols at a DL-to-UL switching time in a subframe may be configured as a GP.

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g., a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

FIG. 5 illustrates an exemplary PDCCH transmission/reception process.

Referring to FIG. 5, a BS may transmit a control resource set (CORESET) configuration to a UE (S502). A CORESET is defined as a resource element group (REG) set having a given numerology (e.g., a subcarrier spacing (SCS), a cyclic prefix (CP) length, and so on). An REG is defined as one OFDM symbol by one (physical) resource block (P) RB. A plurality of CORESETs for one UE may overlap with each other in the time/frequency domain. A CORESET may be configured by system information (e.g., a master information block (MIB)) or higher-layer signaling (e.g., radio resource control (RRC) signaling). For example, configuration information about a specific common CORESET (e.g., CORESET #0) may be transmitted in the MIB. For example, a PDSCH carrying system information block 1 (SIB1) may be scheduled by a specific PDCCH, and CORESET #0 may be used to transmit the specific PDCCH. Further, configuration information about CORESET #N (e.g., N>0) may be transmitted by RRC signaling (e.g., cell-common RRC signaling, UE-specific RRC signaling, or the like). For example, the UE-specific RRC signaling carrying CORESET configuration information may include, but not limited to, various types of signaling such as an RRC setup message, an RRC reconfiguration message, and/or BWP configuration information. Specifically, a CORESET configuration may include the following information/fields.
controlResourceSetId: Indicates the ID of a CORESET.
frequencyDomainResources: Indicates the frequency-domain resources of the CORESET. The resources are indicated by a bitmap in which each bit corresponds to an RB group (=6 (consecutive) RBs). For example, the most significant bit (MSB) of the bitmap corresponds to a first RB group in a BWP. An RB group corresponding to a bit having a bit value of 1 is allocated as frequency-domain resources of the CORESET.
duration: Indicates the time-domain resources of the CORESET. It indicates the number of consecutive OFDM symbols included in the CORESET. The duration has a value between 1 and 3.
cce-REG-MappingType: Indicates a control channel element (CCE)-to-REG mapping type. An interleaved type and a non-interleaved type are supported.
interleaverSize: Indicates an interleaver size.
pdcch-DMRS-ScramblingID: Indicates a value used for PDCCH DMRS initialization. When pdcch-DMRS-ScramblingID is not included, the physical cell ID of a serving cell is used.
precoderGranularity: Indicates a precoder granularity in the frequency domain.
reg-BundleSize: Indicates an REG bundle size.
tci-PresentInDCI: Indicates whether a transmission configuration index (TCI) field is included in DL-related DCI.
tci-StatesPDCCH-ToAddList: Indicates a subset of TCI states configured in pdcch-Config, used for providing quasi-co-location (QCL) relationships between DL RS(s) in an RS set (TCI-State) and PDCCH DMRS ports.

Further, the BS may transmit a PDCCH search space (SS) configuration to the UE (S504). The PDCCH SS configuration may be transmitted by higher-layer signaling (e.g., RRC signaling). For example, the RRC signaling may include, but not limited to, various types of signaling such as an RRC setup message, an RRC reconfiguration message, and/or BWP configuration information. While a CORESET configuration and a PDCCH SS configuration are shown as separately signaled in FIG. 5, for convenience of description, the present disclosure is not limited thereto. For example, the CORESET configuration and the PDCCH SS configuration may be transmitted in one message (e.g., by one RRC signaling) or separately in different messages.

The PDCCH SS configuration may include information about the configuration of a PDCCH SS set. The PDCCH SS set may be defined as a set of PDCCH candidates monitored (e.g., blind-detected) by the UE. One or more SS sets may be configured for the UE. Each SS set may be a UE-specific search space (USS) set or a common search space (CSS) set. For convenience, PDCCH SS set may be referred to as “SS” or “PDCCH SS”.

A PDCCH SS set includes PDCCH candidates. A PDCCH candidate is CCE(s) that the UE monitors to receive/detect a PDCCH. The monitoring includes blind decoding (BD) of PDCCH candidates. One PDCCH (candidate) includes 1, 2, 4, 8, or 16 CCEs according to an aggregation level (AL). One CCE includes 6 REGs. Each CORESET configuration is associated with one or more SSs, and each SS is associated with one CORESET configuration. One SS is defined based on one SS configuration, and the SS configuration may include the following information/fields.
searchSpaceId: Indicates the ID of an SS.
controlResourceSetId: Indicates a CORESET associated with the SS.
monitoringSlotPeriodicity AndOffset: Indicates a periodicity (in slots) and offset (in slots) for PDCCH monitoring.
monitoringSymbolsWithinSlot: Indicates the first OFDM symbol(s) for PDCCH monitoring in a slot configured with PDCCH monitoring. The first OFDM symbol(s) for PDCCH monitoring is indicated by a bitmap with each bit corresponding to an OFDM symbol in the slot. The MSB of the bitmap corresponds to the first OFDM symbol of the slot. OFDM symbol(s) corresponding to bit(s) set to 1 corresponds to the first symbol(s) of a CORESET in the slot.
nrofCandidates: Indicates the number of PDCCH candidates (one of values 0, 1, 2, 3, 4, 5, 6, and 8) for each AL where AL={1, 2, 4, 8, 16}.
searchSpaceType: Indicates CSS or USS as well as a DCI format used in the corresponding SS type.

Subsequently, the BS may generate a PDCCH and transmit the PDCCH to the UE (S506), and the UE may monitor PDCCH candidates in one or more SSs to receive/detect the PDCCH (S508). An occasion (e.g., time/frequency resources) in which the UE is to monitor PDCCH candidates is defined as a PDCCH (monitoring) occasion. One or more PDCCH (monitoring) occasions may be configured in a slot.

Table 3 shows the characteristics of each SS.

TABLE 3

| | Search | | |
|---|---|---|---|
| Type | Space | RNTI | Use Case |
| Type0- | Common | SI-RNTI on a primary cell | SIB Decoding |
| PDCCH | | | |
| Type0A- | Common | SI-RNTI on a primary cell | SIB Decoding |
| PDCCH | | | |
| Type1- | Common | RA-RNTI or TC-RNTI on a | Msg2, Msg4 |
| PDCCH | | primary cell | decoding in |
| | | | RACH |
| Type2- | Common | P-RNTI on a primary cell | Paging |
| PDCCH | | | Decoding |
| Type3- | Common | INT-RNTI, SFI-RNTI, TPC- | |
| PDCCH | | PUSCH-RNTI, TPC-PUCCH- | |
| | | RNTI, TPC-SRS-RNTI, C- | |
| | | RNTI, MCS-C-RNTI, or | |
| | | CS-RNTI(s) | |
| | UE | C-RNTI, or MCS-C-RNTI, or | User specific |
| | Specific | CS-RNTI(s) | PDSCH |
| | | | decoding |

Table 4 shows DCI formats transmitted on the PDCCH.

TABLE 4

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2 0 is used to deliver dynamic slot format information (e.g., a dynamic slot format indicator (SFI)) to a UE, and DCI format 2_1 is used to deliver DL pre-emption information to a UE. DCI format 2 0 and/or DCI format 2_1 may be delivered to a corresponding group of UEs on a group common PDCCH which is a PDCCH directed to a group of UEs.

DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

A CCE-to-REG mapping type is configured as one of an interleaved CCE-to-REG type and a non-interleaved CCE-to-REG type.
Non-interleaved CCE-to-REG mapping (or localized CCE-to-REG mapping) (FIG. 5): 6 REGs for a given CCE are grouped into one REG bundle, and all of the REGs for the given CCE are contiguous. One REG bundle corresponds to one CCE.
Interleaved CCE-to-REG mapping (or distributed CCE-to-REG mapping): 2, 3 or 6 REGs for a given CCE are grouped into one REG bundle, and the REG bundle is interleaved within a CORESET. In a CORESET including one or two OFDM symbols, an REG bundle includes 2 or 6 REGs, and in a CORESET including three OFDM symbols, an REG bundle includes 3 or 6 REGs. An REG bundle size is set on a CORESET basis.

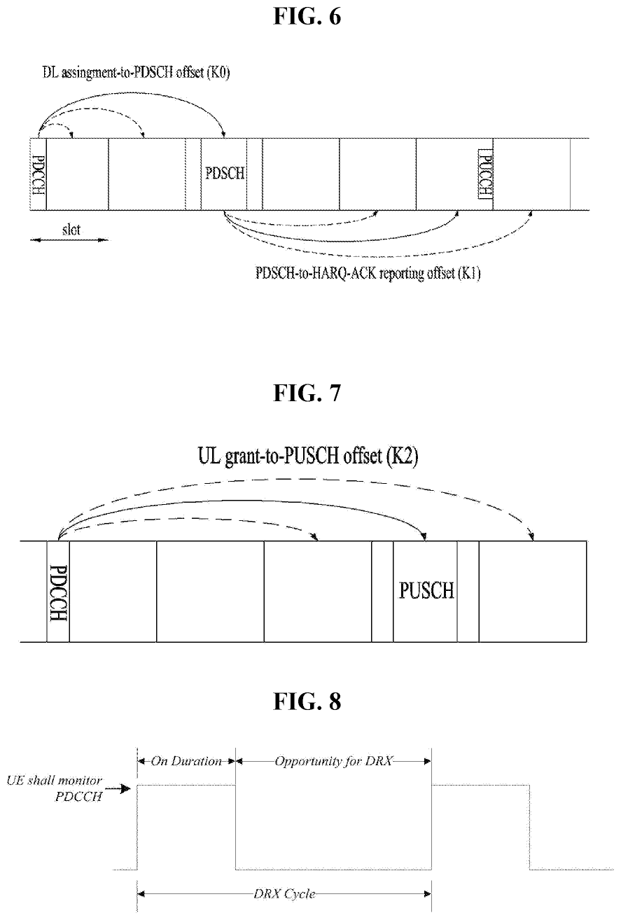

FIG. 6 illustrates an exemplary PDSCH reception and ACK/NACK transmission process. Referring to FIG. 6, the UE may detect a PDCCH in slot #n. The PDCCH includes DL scheduling information (e.g., DCI format 1_0 or DCI format 1_1) and indicates a DL assignment-to-PDSCH offset, K0 and a PDSCH-HARQ-ACK reporting offset, K1. For example, DCI format 1_0 or DCI format 1_1 may include the following information.
Frequency domain resource assignment: Indicates an RB set allocated to a PDSCH.
Time domain resource assignment: Indicates K0 (e.g., slot offset), the starting position (e.g., OFDM symbol index) of the PDSCH in slot #n+K0, and the duration (e.g., the number of OFDM symbols) of the PDSCH.
PDSCH-to-HARQ_feedback timing indicator: Indicates K1.
HARQ process number (4 bits): Indicates the HARQ process ID of data (e.g., a PDSCH or TB).
PUCCH resource indicator (PRI): Indicates a PUCCH resource to be used for UCI transmission among a plurality of PUCCH resources in a PUCCH resource set.

After receiving a PDSCH in slot #(n+K0) according to the scheduling information of slot #n, the UE may transmit UCI on a PUCCH in slot #(n+K1). The UCI may include an HARQ-ACK response to the PDSCH. FIG. 5 is based on the assumption that the SCS of the PDSCH is equal to the SCS of the PUCCH, and slot #n1=slot #(n+K0), for convenience, which should not be construed as limiting the present disclosure. When the SCSs are different, K1 may be indicated/interpreted based on the SCS of the PUCCH.

In the case where the PDSCH is configured to carry one TB at maximum, the HARQ-ACK response may be configured in one bit. In the case where the PDSCH is configured to carry up to two TBs, the HARQ-ACK response may be configured in 2 bits if spatial bundling is not configured and in 1 bit if spatial bundling is configured. When slot #(n+K1) is designated as an HARQ-ACK transmission timing for a plurality of PDSCHs, UCI transmitted in slot #(n+K1) includes HARQ-ACK responses to the plurality of PDSCHs.

Whether the UE should perform spatial bundling for an HARQ-ACK response may be configured for each cell group (e.g., by RRC/higher layer signaling). For example, spatial bundling may be configured for each individual HARQ-ACK response transmitted on the PUCCH and/or HARQ-ACK response transmitted on the PUSCH.

When up to two (or two or more) TBs (or codewords) may be received at one time (or schedulable by one DCI) in a corresponding serving cell (e.g., when a higher layer parameter maxNrofCode WordsScheduledByDCI indicates 2 TBs), spatial bundling may be supported. More than four layers may be used for a 2-TB transmission, and up to four layers may be used for a 1-TB transmission. As a result, when spatial bundling is configured for a corresponding cell group, spatial bundling may be performed for a serving cell in which more than four layers may be scheduled among serving cells of the cell group. A UE which wants to transmit an HARQ-ACK response through spatial bundling may generate an HARQ-ACK response by performing a (bit-wise) logical AND operation on A/N bits for a plurality of TBs.

For example, on the assumption that the UE receives DCI scheduling two TBs and receives two TBs on a PDSCH based on the DCI, a UE that performs spatial bundling may generate a single A/N bit by a logical AND operation between a first A/N bit for a first TB and a second A/N bit for a second TB. As a result, when both the first TB and the second TB are ACKs, the UE reports an ACK bit value to a BS, and when at least one of the TBs is a NACK, the UE reports a NACK bit value to the BS.

For example, when only one TB is actually scheduled in a serving cell configured for reception of two TBs, the UE may generate a single A/N bit by performing a logical AND operation on an A/N bit for the one TB and a bit value of 1. As a result, the UE reports the A/N bit for the one TB to the BS.

There are plurality of parallel DL HARQ processes for DL transmissions at the BS/UE. The plurality of parallel HARQ processes enable continuous DL transmissions, while the BS is waiting for an HARQ feedback indicating successful or failed reception of a previous DL transmission. Each HARQ process is associated with an HARQ buffer in the medium access control (MAC) layer. Each DL HARQ process manages state variables such as the number of MAC physical data unit (PDU) transmissions, an HARQ feedback for a MAC PDU in a buffer, and a current redundancy version. Each HARQ process is identified by an HARQ process ID.

FIG. 7 illustrates an exemplary PUSCH transmission procedure. Referring to FIG. 7, the UE may detect a PDCCH in slot #n. The PDCCH includes DL scheduling information (e.g., DCI format 1_0 or 1_1). DCI format 1_0 or 1_1 may include the following information.
Frequency domain resource assignment: Indicates an RB set assigned to the PUSCH.
Time domain resource assignment: Indicates a slot offset K2 and the starting position (e.g., OFDM symbol index) and duration (e.g., the number of OFDM symbols) of the PUSCH in a slot. The starting symbol and length of the PUSCH may be indicated by a start and length indicator value (SLIV), or separately.

The UE may then transmit a PUSCH in slot #(n+K2) according to the scheduling information in slot #n. The PUSCH includes a UL-SCH TB.

### Paging

The network may (i) access to UEs in RRC_IDLE, RRC_INACTIVE, and RRC_CONNECTED states by paging messages, and (ii) indicate a system information change and an earthquake and tsunami warning system/commercial mobile alert system (ETWS/CMAS) notification to UEs in the RRC_IDLE and RRC_INACTIVE states and UEs in the RRC_CONNECTED state by short messages. Both a paging message and a short message are transmitted based on a P-RNTI-based PDCCH. The paging message is transmitted on a logical channel, paging control channel (PCCH), whereas the short message is directly transmitted on a physical channel, PDCCH. Because the logical channel, PCCH is mapped to a physical channel, PDSCH, the paging message may be understood as scheduled based on a P-RNTI-based PDCCH.

While the UE stays in the RRC_IDLE state, the UE monitors a paging channel for core network (CN)-initiated paging. In the RRC_INACTIVE state, the UE also monitors the paging channel, for radio access network (RAN)-initiated paging. The UE does not need to monitor the paging channel continuously. Paging discontinuous reception (DRX) is defined as monitoring a paging channel only during one paging occasion (PO) per DRX cycle by a UE in the RRC_IDLE or RRC_INACTIVE state. A paging DRX cycle is configured by the network, as follows.

1) In the case of CN-initiated paging, a default cycle is broadcast in system information.

2) In the case of CN-initiated paging, a UE-specific cycle is configured by NAS signaling.

3) In the case of RAN-initiated signaling, a UE-specific cycle is configured by RRC signaling.

Because all of POs of the UE for CN-initiated signaling and RAN-initiated signaling are based on the same UE ID, the two POs overlap with each other. The number of POs in a DRX cycle may be set by system information, and the network may distribute UEs to the POs based on IDs.

When the UE is in the RRC_CONNECTED state, the UE monitors a paging channel in each paging occasion (PO) signaled by system information, for an SI change indication and a PWS notification. In bandwidth adaptation (BA), the RRC_CONNECTED UE monitors only a paging channel in an active BWP in which a configured CSS is located.

In shared spectrum channel access, additional PDCCH monitoring occasions may be configured in a PO of the UE, for paging monitoring. However, when the UE detects a P-RNTI-based PDCCH transmission in its PO, the UE does not need to monitor subsequent PDCCH monitoring occasions in the PO.

To reduce power consumption, the UE may use DRX in the RRC_IDLE and RRC_INACTIVE states. The UE monitors one PO per DRX cycle. A PO is a set of PDCCH monitoring occasions, and may include multiple time slots (e.g., subframes or OFDM symbols) in which paging DCI may be transmitted. One paging frame (PF) is one radio frame and may include one or more POs or the starting points of one or more POs.

In a multi-beam operation, the UE assumes that the same paging message and the same short message are repeated in all transmission beams. The paging message is the same for both of RAN-initiated paging and CN-initiated paging.

Upon receipt of RAN-initiated paging, the UE initiates an RRC connection resume procedure. Upon receipt of CN-initiated paging in the RRC_INACTIVE state, the UE transitions to the RRC IDL state and notifies the NAS of the CN-initiated paging.

A PF and a PO for paging are determined in the following manner:
An SFN for the PF is determined by:

(SFN+PF_offset)mod T=(T div N)*(UE_ID mod N)
An index i_s indicating the index of the PO is determined by:

i_s=floor(UE_ID/N)mod Ns

The following parameters may be used to calculate the PF and i_s above.
T: The DRX cycle of the UE (T is determined by the smallest of UE-specific DRX values (if configured by RRC and/or an upper layer) and a default DRX value broadcast in system information. In the RRC_IDLE state, if UE-specific DRX is not configured by an upper layer, the default value is applied).
N: Number of total paging frames in T
Ns: Number of POs for a PF
PF_offset: Offset used for PF determination
UE_ID: 5G-S-TMSI mod 1024

### DRX (Discontinuous Reception)

### (1) RRC_Connected DRX

FIG. 8 is a diagram illustrating a DRX operation of a UE according to an embodiment of the present disclosure.

The UE may perform a DRX operation in the afore-described/proposed procedures and/or methods. A UE configured with DRX may reduce power consumption by receiving a DL signal discontinuously. DRX may be performed in an RRC_IDLE state, an RRC_INACTIVE state, and an RRC_CONNECTED state. The UE performs DRX to receive a paging signal discontinuously in the RRC_IDLE state and the RRC_INACTIVE state. DRX in the RRC_CONNECTED state (RRC_CONNECTED DRX) will be described below.

Referring to FIG. 8, a DRX cycle includes an On Duration and an Opportunity for DRX. The DRX cycle defines a time interval between periodic repetitions of the On Duration. The On Duration is a time period during which the UE monitors a PDCCH. When the UE is configured with DRX, the UE performs PDCCH monitoring during the On Duration. When the UE successfully detects a PDCCH during the PDCCH monitoring, the UE starts an inactivity timer and is kept awake. On the contrary, when the UE fails in detecting any PDCCH during the PDCCH monitoring, the UE transitions to a sleep state after the On Duration. Accordingly, when DRX is configured, PDCCH monitoring/reception may be performed discontinuously in the time domain in the afore-described/proposed procedures and/or methods. For example, when DRX is configured, PDCCH reception occasions (e.g., slots with PDCCH SSs) may be configured discontinuously according to a DRX configuration in an embodiment of the present disclosure. On the contrary, when DRX is not configured, PDCCH monitoring/reception may be performed continuously in the time domain. For example, when DRX is not configured, PDCCH reception occasions (e.g., slots with PDCCH SSs) may be configured continuously in an embodiment of the present disclosure. Irrespective of whether DRX is configured, PDCCH monitoring may be restricted during a time period configured as a measurement gap.

Table 5 describes a DRX operation of a UE (in the RRC_CONNECTED state). Referring to Table 5, DRX configuration information is received by higher-layer signaling (e.g., RRC signaling), and DRX ON/OFF is controlled by a DRX command from the MAC layer. Once DRX is configured, the UE may perform PDCCH monitoring discontinuously in performing the afore-described/proposed procedures and/or methods.

TABLE 5

| | Type of signals | UE procedure |
|---|---|---|
| 1st | RRC signalling | Receive DRX configuration information |
| step | (MAC- | |
| | CellGroupConfig) | |
| 2nd | MAC CE | Receive DRX command |
| Step | ((Long) DRX | |
| | command MAC CE) | |
| 3rd | — | Monitor a PDCCH during an on-duration |
| Step | | of a DRX cycle |

MAC-CellGroupConfig includes configuration information required to configure MAC parameters for a cell group. MAC-CellGroupConfig may also include DRX configuration information. For example, MAC-CellGroupConfig may include the following information in defining DRX.-Value of drx-OnDurationTimer: defines the duration of the starting period of the DRX cycle.
Value of drx-InactivityTimer: defines the duration of a time period during which the UE is awake after a PDCCH occasion in which a PDCCH indicating initial UL or DL data has been detected
Value of drx-HARQ-RTT-TimerDL: defines the duration of a maximum time period until a DL retransmission is received after reception of a DL initial transmission.
Value of drx-HARQ-RTT-TimerDL: defines the duration of a maximum time period until a grant for a UL retransmission is received after reception of a grant for a UL initial transmission.
drx-LongCycleStartOffset: defines the duration and starting time of a DRX cycle.
drx-ShortCycle (optional): defines the duration of a short DRX cycle.

When any of drx-OnDurationTimer, drx-InactivityTimer, drx-HARQ-RTT-TimerDL, and drx-HARQ-RTT-TimerDL is running, the UE performs PDCCH monitoring in each PDCCH occasion, staying in the awake state.

### RRC_IDLE DRX

In the RRC_IDLE and RRC_INACTIVE states, DRX is used to receive a paging signal discontinuously. For simplicity, DRX performed in the RRC_IDLE (or RRC_INACTIVE) state will be referred to as RRC_IDLE DRX.

Therefore, if DRX is configured, PDCCH monitoring/reception may be performed discontinuously in the time domain in performing the above-described/proposed procedures and/or methods are performed.

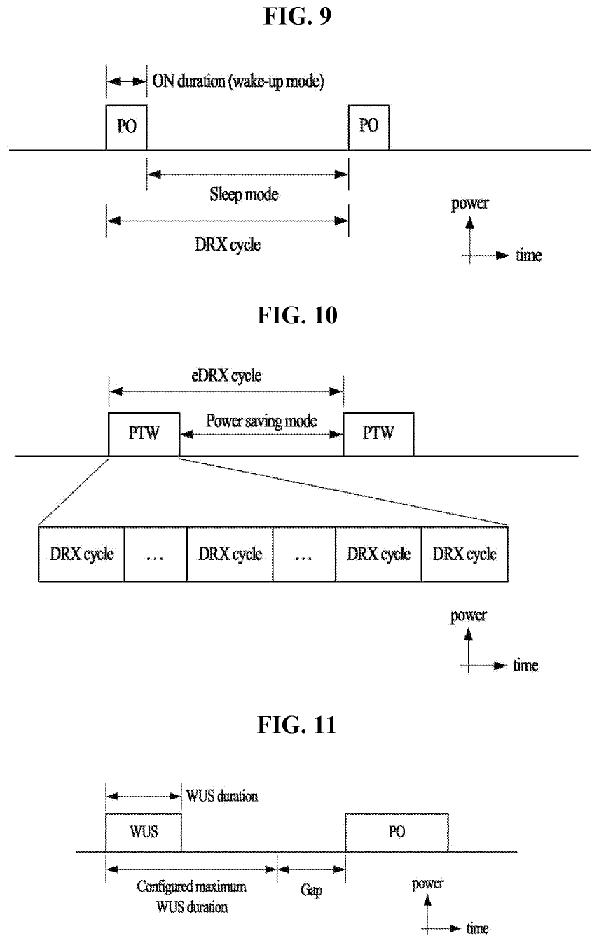

FIG. 9 illustrates an exemplary DRX cycle for paging.

Referring to FIG. 9, DRX may be configured for discontinuous reception of a paging signal. The UE may receive DRX configuration information from the BS by higher-layer (e.g., RRC) signaling. The DRX configuration information may include configuration information related to a DRX cycle, a DRX offset, a DRX timer, and the like. The UE repeats an On duration and a Sleep duration according to the DRX cycle. The UE may operate in a wakeup mode during the On duration and in a sleep mode during the Sleep duration.

In the wakeup mode, the UE may monitor a PO to receive a paging message. A PO means a time resource/interval (e.g., subframe or slot) in which the UE expects to receive a paging message. PO monitoring includes monitoring a PDCCH (MPDCCH or NPDCCH) scrambled with a P-RNTI (hereinafter, referred to as a paging PDCCH) on a PO. The paging message may be included in the paging PDCCH or in a PDSCH scheduled by the paging PDCCH. One or more POs may be included in a paging frame (PF), and the PF may be periodically configured based on a UE ID. A PF may correspond to one radio frame, and the UE ID may be determined based on the International Mobile Subscriber Identity (IMSI) of the UE. When DRX is configured, the UE monitors only one PO per DRX cycle. When the UE receives a paging message indicating a change of its ID and/or system information on a PO, the UE may perform an RACH procedure to initialize (or reconfigure) a connection with the BS, or receive (or obtain) new system information from the BS. Therefore, PO monitoring may be performed discontinuously in the time domain to perform an RACH procedure for connection to the BS or to receive (or obtain) new system information from the BS in the above-described procedures and/or methods.

FIG. 10 illustrates an extended DRX (eDRX) cycle.

According to the DRX cycle configuration, the maximum cycle duration may be limited to 2.56 seconds. However, in the case of a UE that intermittently performs data transmission/reception, such as an MTC UE or an NB-IoT UE, unnecessary power consumption may occur during the DRX cycle. In order to further reduce the power consumption of the UE, a method of significantly extending the DRX cycle based on a power saving mode (PSM) and a paging time window or paging transmission window (PTW) has been introduced. The extended DRX cycle is simply referred to as an eDRX cycle. Specifically, paging hyper-frames (PHs) are periodically configured based on the UE ID, and a PTW is defined in the PHs. The UE may perform a DRX cycle in the PTW duration to switch to the wakeup mode on the PO thereof to monitor the paging signal. One or more DRX cycles (e.g., wake-up mode and sleep mode) of FIG. 9 may be included in the PTW duration. The number of DRX cycles in the PTW duration may be set by the BS through a higher layer (e.g., RRC) signal.

### WUS (Wake-Up Signal)/PEI (Paging Early Indication)

In LTE Rel-15 Narrowband Internet of Things (NB-IoT) and Machine Type Communication (MTC), a wake-up signal (WUS) was introduced to save power of a UE. The WUS is a signal indicating preliminarily whether there is an actual paging transmission in a paging SS at a specific position. When the BS wants to transmit paging in a PO at a specific position, the BS may transmit a WUS at WUS transmission position(s) associated with the PO. The UE monitors the WUS transmission positions associated with the PO at the specific position. Upon detection of the WUS at the WUS transmission position(s), the UE may expect that paging will be transmitted in the PO, whereas when failing to detect the WUS at the WUS transmission position(s), the UE may not expect paging in the PO. The gain of power saving may be achieved by this operation. In LTE Rel-16 NB-IoT and MTC, a UE-group WUS was introduced to increase the power saving gain of the Rel-15 WUS. The UE-group WUS may advantageously reduce an unnecessary wakeup probability of a UE by using a WUS transmission position and sequence determined based on the UE-group ID of the UE.

FIG. 11 is a diagram illustrating a WUS in an LTE system. Referring to FIG. 11, in MTC and NB-IoT, the WUS may be used to reduce power consumption related to paging monitoring. The WUS is a physical layer signal indicating whether a UE is supposed to monitor a paging signal (e.g., an MPDCCH/NPDCCH scrambled with a P-RNTI) according to a cell configuration. For a UE which is not configured with eDRX (i.e., configured only with DRX), the WUS may be associated with one PO (N=1). On the contrary, for a UE configured with eDRX, the WUS may be associated with one or more POs (N>1). Upon detection of the WUS, the UE may monitor N POs after being associated with the WUS. When failing to detect the WUS, the UE may maintain sleep mode by skipping PO monitoring until the next WUS monitoring. The UE may receive WUS configuration information from the BS and monitor the WUS based on the WUS configuration information. The WUS configuration information may include, for example, a maximum WUS duration, the number of consecutive POs associated with the WUS, and gap information. The maximum WUS duration may refer to a maximum time period during which the WUS may be transmitted, and may be expressed as a ratio to a maximum repetition number (e.g., Rmax) related to a PDCCH (e.g., MPDCCH or NPDCCH). Although the UE may expect repeated WUS transmissions within the maximum WUS duration, the number of actual WUS transmissions may be less than a maximum number of WUS transmissions within the maximum WUS duration. For example, the number of WUS repetitions may be small for a UE in good coverage. A resource/occasion in which the WUS may be transmitted within the maximum WUS duration is referred to as a WUS resource. The WUS resource may be defined as a plurality of consecutive OFDM symbols by a plurality of consecutive subcarriers. The WUS resource may be defined as a plurality of consecutive OFDM symbols by a plurality of consecutive subcarriers in a subframe or slot. For example, the WUS resource may be defined as 14 consecutive OFDM symbols by 12 consecutive subcarriers. Upon detection of the WUS, the UE does not monitor the WUS until a first PO associated with the WUS. When the WUS is not detected during the maximum WUS duration, the UE does not monitor a paging signal in POs associated with the WUS (or the UE remains in the sleep mode).

In a communication system such as NR, it may be indicated by a paging early indication (PEI) (e.g., a PEI based on a sequence or DCI) whether the UE should monitor paging DCI in a PO or whether paging DCI is provided. When the UE succeeds in detecting the PEI, the UE monitors the paging DCI (and/or a PDSCH carrying a corresponding paging message). When failing in detecting the PEI, the UE may skip monitoring of the paging DCI in the PO.

### Paging Occasion for Network Energy Saving

Energy saving of BSs is considered important in wireless communication systems including 3GPP, because it may contribute to building eco-friendly networks and reducing the operational expenditure (OPEX) of communication service providers by reducing carbon emissions. Particularly, since along with the introduction of 5G communication, high transmission rates are required, a BS should be equipped with more antennas and provide services in a wider bandwidth and frequency band. As a result, recent studies have revealed that the energy cost of BSs has reached up to 20% of the total OPEX. Due to the increased interest in BS energy saving, research on network energy savings (NES) is under discussion in 3GPP NR release 18.

Specifically, how to achieve a more efficient operation dynamically and/or semi-statically and finer granularity adaptation of transmissions and/or receptions in one or more of network energy saving techniques in time, frequency, spatial, and power domains are discussed, together with potential assistance/feedback from a UE and potential UE assistance information.

In this context, a BS operation for improving the NES efficiency of a BS is defined, and a UE operation is defined in consideration of the BS operation.

The BS may operate technologies such as controlling on/off for a certain duration in the time axis for obtaining NES, controlling transmission/reception resources for UE-common or UE-specific signals/channels, changing the amount of frequency-axis resources, controlling transmission power, or turning antenna ports or TRPs on/off in a spatial domain, and in this regard, a state in which such technologies (defined as NES_tech for convenience) are applied may be defined as an NES mode or an NES state. The BS may inform the UE of which NES_tech(s) are applied for each NES_tech (or a group thereof) (Approach 1), or may pre-configure a corresponding NES_tech (or group(s) thereof) for each code-point of a specific indicator (the corresponding indicator may be indicated by DCI, MAC CE, or the like, or may be configured by higher layer signaling) (Approach 2). For Approach 1, the UE may define the corresponding state as an NES mode or an NES state when at least one NES_tech is applied, or the corresponding state may be referred to as a different NES mode or a different NES state depending on which NES_tech is applied. For Approach 2, for example, when there is a 1-bit indicator, if ‘0’ has no corresponding NES_tech and ‘l’ has one or more NES_techs associated, the UE may define the corresponding state as the NES mode or the NES state when receiving ‘l’ from the corresponding indicator. As another example, when there is a 2-bit indicator, if ‘00’ does not have a corresponding NES_tech, ‘01’ has one or more NES_tech_As associated, ‘10’ has one or more NES_tech_B associated, and ‘11’ has one or more NES_tech_C associated, the UE may define the corresponding state as the NES mode or the NES state when being instructed to a code point other than ‘00’ from the corresponding indicator, define the corresponding state as NES state #1 when being instructed to ‘01’, define the corresponding state as NES state #2 when being instructed to ‘10’, and define the corresponding state as NES state #3 when being instructed to ‘11’, and may also distinguish, for each code-point, whether the corresponding state is an NES state or not, or which NES state the state corresponds to. In the present disclosure, the NES state and the NES mode are all used as terms referring to the same concept.

In an idle/inactive mode, the UE needs to monitor a PO periodically. However, when performing the NES mode in terms of the BS, there may be a possibility that an actual paging transmission/reception procedure is not performed at locations of these POs, and in this case, an unnecessary paging monitoring operation of the UE may be disadvantageous in terms of power consumption. To prevent excessively increasing paging latency, the BS may need to periodically perform paging transmission and reception procedures through a PO. Considering these perspectives, there may be a need for a method of determining a reference of monitoring a PO between NES UEs and the BS within a period in which the NES mode operates.

From another perspective, an impact of paging transmission and reception on UEs that do not support the NES mode needs to be considered. For general UEs that do not support the NES mode, even if the BS changes the configuration of PF/PO depending on whether the NES mode is applied, the UEs may not recognizing this, which may result in a significant increase in paging latency or a decrease in the energy saving efficiency of the BS.

To resolve these problems, this specification proposes a configuration method of PF and PO that enables an NES UE to operate in an NES mode and proposes signaling therefor and operations of a BS and a UE. The proposed methods may provide an advantageous effect in considering the paging reception performance of general UEs that do not support an NES mode.

For convenience, the description is based on the characteristics and structure of the NR system and NES, but is not limited thereto, and the proposed methods may be applied to all structures and services of wireless communication transmission and reception. One or more of the proposed methods may be applied in combination or independently without any combination. Terms, symbols, sequences, and the like may be replaced with other terms, symbols, sequences, and the like. Hereinafter, an operation of network energy saving (NES) of the BS may be considered, and a method is proposed in which a UE supporting the operation determines a paging reception location (i.e. PF and PO) by considering an NES operation state of the BS and performs an operation based thereon. As a detailed method for determining a paging reception location considering the NES operation state the BS, a method may be used in which the BS determines and applies a separate paging DRX parameter (hereinafter referred to as NES-paging-para) for a UE having the capability of the NES mode (hereinafter referred to as NES-Cap), and the UE receives NES-paging-para information from the BS and performs a paging reception procedure based on the received information.

The configuration, application, and instruction methods of the NES-paging-para may be used in combination with one or more of the following methods.

### [Proposal 1] Method to Include Separate Paging DRX Cycle for NES UE in NES-Paging-Para

For example, a method of configuring a separate paging DRX cycle for an NES UE and determining locations of a PF and a PO by applying the configured paging DRX cycle by the NES UE is proposed. In this case, a separate paging DRX cycle for the NES UE may be received by the UE through a higher layer signal (e.g. SIB or dedicated RRC signal) transmitted by the BS. As a detailed example, the paging DRX cycle may correspond to T (i.e. DRX cycle of the UE) described in section 7.1 of TS 38.304 based on the 3GPP NR standard and may be a method for controlling this.

The proposed method has an advantage of being useful in reducing unnecessary transmission and reception operations of NES UEs at locations of the PF/PO in which a BS performing an NES operation does not actually schedule a PDCCH/PDSCH by configuring a period of the PF and PO that NES UEs expect to receive to be larger than that of general UEs.

The size of the paging DRX cycle (hereinafter referred to as an NES-paging DRX cycle) of the NES UE provided through the NES-paging-para may be configured to have a multiple relationship with the size of the paging DRX cycle used by a general UE. For example, when the size of the paging DRX cycle used by a general UE is a value of T_normal, the size of the NES-paging DRX cycle may be determined to be expressed as the product of T_normal and an arbitrary integer, m. This has an advantage of saving NW overhead for paging transmission and reception by providing a structure in which an NES UE and a general UE may share the location of POs in a cycle of the NES-paging DRX cycle, especially when considering an environment in which a PO of the NES UE and a PO of the general UE may partially overlap each other, and it may be expected to have an advantageous effect in that at least one paging transmission and reception opportunity may be provided per NES-paging DRX cycle even when the NES UE misses indication information of the BS for NES mode switching.

The NES-paging-para provided by the BS to the UE may include a value of the NES-paging DRX cycle, or an integer m multiplied by the paging DRX cycle of a general UE.

The applicability of the proposed method may be determined depending on an NES mode. As a detailed method, a section to which the NES-paging-para is applied may be determined to be limited to a section to which the NES mode is applied. Conversely, in a section to which the NES mode is not applied, the paging DRX cycle configured for the general UE may be applied to determine the locations of the PF and PO.

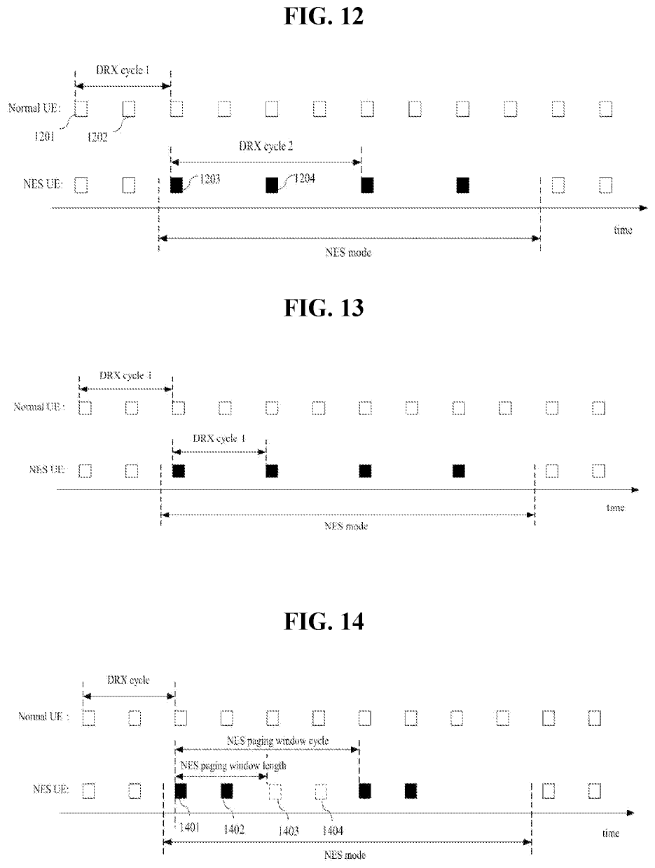

FIG. 12 shows an example of Proposal 1, and Proposal 1 is not limited to the example of FIG. 12. In FIG. 12, it is assumed that two PFs are configured per paging DRX cycle. In DRX cycle 1, a plurality of PFs (e.g., PF 1201 and PF 1202) are included, and Normal UE monitors 1 PF per DRX cycle according to a UE ID thereof. Each Normal UE may select one PF out of a total of 2 PFs configured per DRX cycle based on the UE ID. For example, Normal UE 1 may monitor the PF 1201, not the PF 1202, and Normal UE 2 may monitor the PF 1202, not the PF 1201.

In FIG. 12, it is assumed that a length of the NES-paging DRX cycle used when the NES UE is in an NES mode is twice a length of the paging DRX cycle used by a general UE. The NES UE operates based on the NES-paging DRX cycle (i.e., DRX cycle 2) rather than the DRX cycle 1 during an NES mode period, and the NES-paging DRX cycle (i.e., DRX cycle 2) includes a plurality of PFs (e.g., PF 1203 and PF 1204). The NES UE monitors one PF per NES-paging DRX cycle according to a UE ID thereof. For convenience, it is assumed in FIG. 12 that the NES UE monitors the PF 1202.

### [Proposal 2] Method to Include Separate Number of Total PFs in Paging DRX Cycle for NES UE in NES-Paging-Para

For example, a method of configuring a separate number of total PFs in paging DRX cycle for an NES UE and determining locations of a PF and PO by applying the configured number by the NES UE is proposed. In this case, a separate number of total PFs in paging DRX cycle for the NES UE may be received by the UE through a higher layer signal (e.g. SIB or dedicated RRC signal) transmitted by the BS. For example, the number of total PFs in paging DRX cycle may correspond to N (i.e. number of total paging frames in T) described in section 7.1 of TS 38.304 based on the 3GPP NR standard, and a method of controlling the same may be considered.

The proposed method has an advantage of being useful in reducing unnecessary transmission and reception operations of a BS by increasing a period of PF/PO for which a BS performing an NES operation schedules an actual PDCCH/PDSCH while maintaining the period of PF and PO that an NES UE expects to receive to be the same as that of a general UE.

The size of the number of total PFs in paging DRX cycle (hereinafter referred to as NES-Num_PF) of the NES UE provided through the NES-paging-para may be configured to have a divisor relationship with the size of the number of total PFs in paging DRX cycle used by the general UE. For example, when the size of the number of total PFs in paging DRX cycle used by the general UE is a value of N_normal, N_normal may be expressed as the product of NES-Num_PF, which is an integer, and m, which is an arbitrary integer. This has an advantage of saving NW overhead for paging transmission and reception by providing a structure in which the NES UE and the general UE may share the location of a PO in a cycle of the NES-paging DRX cycle, especially when considering an environment in which a PO of the NES UE and a PO of the general UE partially overlap each other.

For example, the NES-paging-para provided by the BS to the UE may include a value of NES-Num_PF, or an integer m multiplied by the number of total PFs in paging DRX cycle of the general UE.

The applicability of the proposed method may be determined depending on an NES mode. As a detailed method, a section to which the NES-paging-para is applied may be determined to be limited to a section to which the NES mode is applied. Conversely, in a section to which the NES mode is not applied, the number of total PFs in paging DRX cycle configured for the general UE may be applied to determine the locations of the PF and PO.

FIG. 13 shows an example of Proposal 2. In FIG. 12, a paging DRX cycle is always maintained constant regardless of an NES mode, and a case in which the size of the number of total PFs in paging DRX cycle expected by a general UE is 2 is considered. In this case, the NES UE is shown to perform an operation of determining the location of a PF by changing a value of NES-Num_PF to 1 within a section in which the NES mode is applied.

The method of Proposal 2 may be used in combination with the method of Proposal 1. In this case, the UE may determine the location of the PF applied in the NES mode by combining a value of the NES-paging DRX cycle configured through the NES-paging-para and a value of NES-Num_PF.

### [Proposal 3] Method of Providing PF/PO Skipping Related Information of NES UE Through NES-Paging-Para

For example, a method of configuring information (hereinafter referred to as PF/PO skipping information) to allow the NES UE to skip some PFs/POs without monitoring the same and determining the locations of a PF and PO that are actual monitoring targets by applying the configured information by the NES UE is proposed. In this case, PF/PO skipping information for the NES UE may be received by the UE through a higher layer signal (e.g. SIB or dedicated RRC signal) transmitted by the BS.

The PF/PO skipping information may be defined as a section in which actual paging monitoring is performed among the locations of the PF and PO that are to be expected to be configured through the paging parameter configured by the UE. For example, the UE may perform paging PDCCH monitoring only for the locations of the PF and PO that satisfy a specific condition based on PF/PO skipping information from among the locations of the PF and PO configured through paging DRX parameters, and may be configured not to expect transmission or reception of paging PDCCH for a section that does not satisfy the conditions.

Based on the PF/PO skipping information, a specific condition and specific implementations of the proposed method may be used as one of the following options.

### (Option 3-1) Method to Include Paging Window Information of NES UE in NES-Paging-Para

For example, a method of configuring an NES paging window for an NES UE and determining locations of a PF and a PO by applying the configured paging DRX cycle by the NES UE is proposed. In this case, the NES paging window may be received by the UE through a higher layer signal (e.g. SIB or dedicated RRC signal) transmitted by the BS. The NES paging window may be defined as a period during which the UE performs paging monitoring at the locations of the actual PF and PO. For example, the UE may perform paging PDCCH monitoring only for the locations of the PF and PO that belong to the NES paging window period from among the locations of the PF and PO configured through paging DRX parameters, and may be configured not to expect transmission or reception of paging PDCCH for a section that does not satisfy the conditions.

The proposed method has an advantage of being useful in reducing unnecessary transmission and reception operations of a BS by increasing a period of PF/PO for which a BS performing an NES operation schedules an actual PDCCH/PDSCH while maintaining the period of PF and PO that an NES UE expects to receive to be the same as that of a general UE.

To configure the NES paging window, NES-paging-para may include information about a period of the NES paging window, a length of a section, and/or a starting position. In this case, information of the NES paging window may be determined as a function of parameters used to determine the location of the PF/PO. For example, the period and length of the section of the NES paging window may be configured and indicated as a multiple of the size of the paging DRX cycle.

The applicability of the proposed method may be determined depending on an NES mode. As a detailed method, a section to which the NES-paging-para is applied may be determined to be limited to a section to which the NES mode is applied. Conversely, in a section to which the NES mode is not applied, the method by which a general UE determines the locations of the PF and PO may be applied in the same manner.

FIG. 14 shows an example of Proposal 3. FIG. 14 shows an example in which the size of the NES paging window is twice the paging DRX cycle and a period of the NES paging window is configured to four times the paging DRX cycle.

Referring to FIG. 14, the size of the paging DRX cycle and the number of total PFs in paging DRX cycle are always maintained constant regardless of whether the NES mode is activated. For example, the size of the paging DRX cycle and the number of total PFs in the paging DRX cycle may be commonly configured for the NES UE supporting the NES mode and the Normal UE not supporting the NES mode (or for which the NES configuration is not provided). The NES UE may only consider PFs 1401 and 1402 included in the NES paging window within a section to which the NES mode is applied, and may not expect transmission or reception of paging from PFs 1403 and 1403 located outside the NES paging window. For example, the NES UE may operate assuming that the PFs 1403 and 1403, which are located outside the NES paging window, are not configured.

### (Option 3-2) Method to Include Enabled Monitoring Cycle Information of NES UE in NES-Paging-Para

For example, a method of configuring an Enabled monitoring cycle for an NES UE and determining locations of a PF and a PO by applying the configured paging DRX cycle by the NES UE is proposed. In this case, the enabled monitoring cycle for the NES UE may be received by the UE through a higher layer signal (e.g. SIB or dedicated RRC signal) transmitted by the BS. Information of the Enabled monitoring cycle may be defined as information including a cycle and a reference point for determining a section in which the UE performs actual paging monitoring from among the locations of the PF and PO. For example, the NES UE may perform paging PDCCH monitoring at a cycle configured by the Enabled monitoring cycle for some of the locations of the PF and PO configured through paging DRX parameters, and may configure not to expect transmission or reception of paging PDCCH for other sections.

The proposed method has an advantage of being useful in reducing unnecessary transmission and reception operations of a BS by increasing a period of PF/PO for which a BS performing an NES operation schedules an actual PDCCH/PDSCH while maintaining the period of PF and PO that an NES UE expects to receive to be the same as that of a general UE.

In the proposed method, a period of the Enabled monitoring cycle may be configured to have a multiple value of the paging DRX cycle. This may provide a structure advantageous for increasing a period in which paging reception may be expected while maintaining the locations of the PF and PO configured in terms of a UE. To this end, the BS may provide an integer m through NES-paging-para, and may determine a value derived by multiplying a value m by the paging DRX cycle as a period of the Enabled monitoring cycle.

In the proposed method, a reference point of the Enabled monitoring cycle may be a value determined in absolute time units such as SFN, which may provide an advantageous effect in preventing omission of paging that may occur due to information mismatch between the BS and the UE. Alternatively, the reference point of the Enabled monitoring cycle may be configured as a time point at which the NES mode of the BS is started and information about the same is applied to the UE, or a time point at which the UE provides feedback about the same, or another agreed time point determined based on these time points (e.g. a value determined in absolute time units such as SFN after an event occurs).

The applicability of the proposed method may be determined depending on an NES mode. As a detailed method, a section to which the NES-paging-para is applied may be determined to be limited to a section to which the NES mode is applied. Conversely, in a section to which the NES mode is not applied, the method by which a general UE determines the locations of the PF and PO may be applied in the same manner.

### [Proposal 4] Method of Periodically Hopping Locations of PF/PO of NES UE

For example, a method of periodically hopping locations of a PF and/or a PO for an NES UE in the time domain is proposed. In this case, information related to hopping of a PF/PO for the NES UE may be received by the UE through a higher layer signal (e.g. SIB or dedicated RRC signal) transmitted by the BS. As a specific method of the proposed method, the location of the PF or PO used by the NES UE may be determined by periodically hopping the location of the PF or PO used by the general UE.

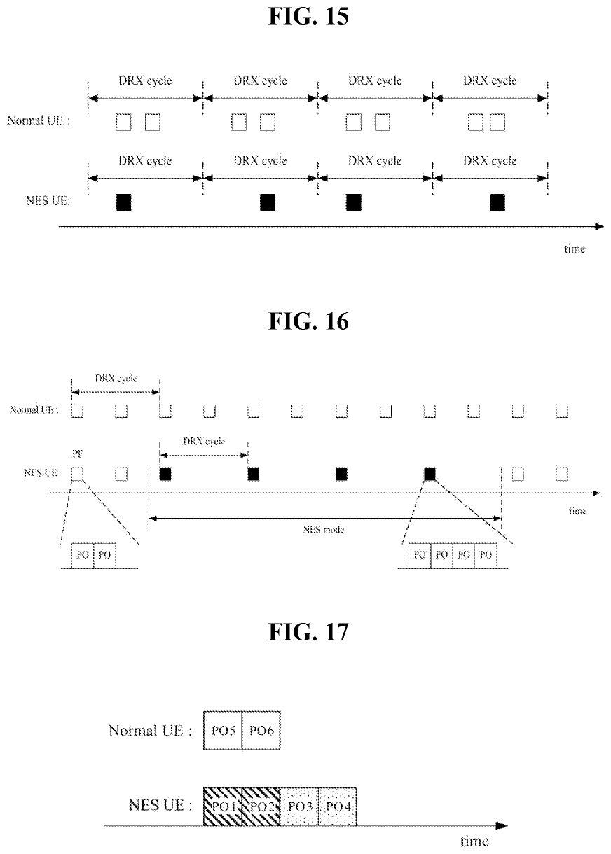

FIG. 15 shows an example of Proposal 4. The illustrated example shows an example in which Proposal 2 is applied when DRX cycles of the NES UE and the general UE are the same and Proposal 4 is applied when the number of total PFs in paging DRX cycles varies. In FIG. 15, the NES UE applies different references for selecting a PF based on a DRX cycle, which has the same effect as a structure in which the locations of the PFs corresponding to different UE groups are hopped and selected based on the PF of a general UE.

The proposed method may generate an effect of evenly distributing an overlap frequency when the locations of the PF and PO that the NES UE expects to receive overlap the locations of the PF and PO that the general UE expects to receive. This may be advantageous in preventing unnecessary wake-ups from increasing for UEs using a PF when the locations of specific PFs frequently overlap each other, and also in preventing general UEs monitoring a PF in which overlap does not frequently occur from not receiving paging for a long period of time during a period in which an NES mode of the BS is maintained, which may lead to power saving of the UE and reduction in paging latency.

As one detailed method of applying the proposed method, a method in which the size of a PF offset used to determine the expected PF of the NES UE is periodically changed may be considered. For example, when the location of a PF of the NES UE is determined according to the PF determination equation (i.e. (SFN+PF_offset) mod T=(T div N)*(UE_ID mod N)) described in Section 7.1 of TS 38.304 based on the 3GPP NR standard, one of the examples below may be applied and implemented. In this case, the two examples have the same effect in different methods, and that is, with respect to a method in which the PF offset is changed periodically and a value of the PF offset that is changed in this case is determined based on the location of the PF of the general UE, the concept of the present disclosure is not limited to the following example.

(Example 4-1) A method of determining a PF_offset value of an NES UE using the equation PF_offset=T/N*m+PF_offset_N(m) may be considered. In this case, a value m means an integer that changes for each hopping period, and a value of PF_offset_N(m) means a value determined by the value m from among a plurality of PF_offset values configured for a general UE.

(Example 4-2) A method of determining a PF_offset value of an NES UE by the equation PF_offset=PF_offset_N(m) and using the formula UE_ID=UE_ID_real+m may also be considered. In this case, a value m means an integer that changes for each hopping period, and a value of PF_offset_N(m) means a value determined by the value m from among a plurality of PF_offset values configured for a general UE. UE_ID means a UE_ID value applied to the formula, and UE_ID_real means an actual UE ID value determined by the 5G-S-TMSI of the UE (i.e., UE_ID_real=5G-S-TMSI mod 1024).

### [Proposal 5] Method to Include PO Burst Information Per PF for NES UE in NES-Paging-Para

For example, a method of configuring a PO burst in a PF configured for an NES UE and determining locations of a PF and a PO by applying the configured paging DRX cycle by the NES UE is proposed. In this case, information about the PO burst for the NES UE may be received by the UE through a higher layer signal (e.g. SIB or dedicated RRC signal) transmitted by the BS. The PO burst refers to a structure in which PO is continuously generated within the PF.

As a detailed example, the configuration method of the PO burst may be a method controlled by Ns (i.e. number of paging occasions for a PF) described in section 7.1 of TS 38.304 based on the 3GPP NR standard. This may be for separately controlling the number of POs included per PF for an NES UE.

As another detailed example, the configuration method of the PO burst may be a method controlled by a combination of Ns (i.e. number of paging occasions for a PF) and N (i.e. number of total paging frames in T) described in section 7.1 of TS 38.304 based on the 3GPP NR standard. This may be determined such that when values of N and Ns for the NES UE are N_NES and Ns_NES, respectively, and values of N and Ns for the general UE are N_Normal and Ns_Normal, the condition of Ns_NES=Ns_Normal*(N_Normal/N_NES) is satisfied. This may be provided to ensure that a total number of POs belonging to one DRX cycle is expected to be the same for an NES UE and a general UE, which may be advantageous in maintaining the same level at which UE grouping is performed.

The proposed method has an advantage of being useful to increase an energy saving effect of a BS by configuring a long period of a PF and PO for an NES UE while at the same time increasing a period for the BS to continuously maintain an NES operation.

For example, the NES-paging-para provided to the UE by the BS may include Ns (i.e. number of paging occasions for a PF) of the NES UE, or N (i.e. number of total paging frames in T) of the general UE of the NES UE, and may be a value to be implicitly calculated by the N value and other parameters.

The applicability of the proposed method may be determined depending on an NES mode. As a detailed method, a section to which the NES-paging-para is applied may be determined to be limited to a section to which the NES mode is applied. Conversely, in a section to which the NES mode is not applied, the number of paging occasions for a PF configured for the general UE may be applied to determine the locations of the PF and PO.

FIG. 16 shows an example of Proposal 5. In FIG. 16, a paging DRX cycle is always maintained constant regardless of an NES mode, and a case in which the size of the number of total PFs in paging DRX cycle expected by a general UE is 2 is considered. In this case, the NES UE is shown to perform an operation of determining the location of a PF by changing a value of NES-Num_PF to 1 within a section in which the NES mode is applied. In the illustrated example, in a section to which the NES mode is not applied, 2 POs are configured per PF, and in a section to which the NES mode is applied, 4 POs are configured per PF and applied.

Method of Distributing UE IDs to POs Configured within PO Burst

The proposed method may include a method of determining that the number of UE IDs is distributed unequally in each PO within each PO burst when configuring PO bursts for an NES UE. This may be provided to consider a phenomenon in which a probability of paging occurring differs depending on a location of each PO, when considering a case in which some of the POs of the NES UE overlap a PO of a general UE within the NES burst section, as in the example of FIG. 17. In this case, in the locations of POs in which overlap occurs (PO1 and PO5, and PO2 and PO6 in the illustrated example), a probability of paging occurrence increases because both a general UE and an NES UE expect paging, and on the other hand, in the locations of POs in which overlap does not occur (PO3 and PO4 in the illustrated example), a probability of paging occurrence may be relatively low because only an NES UE exist. This may affect power consumption of the UE due to a paging procedure, which may cause an imbalance in power consumption between UEs. To resolve this problem, a ratio of UE IDs distributed to each PO within a PO burst may be configured to be different for each PO. As a detailed method, when M POs are configured in a PO burst, each PO may be assigned a weight factor for UE ID distribution, and the NES UE may be determined to select a PO within the PO burst based on the weight factor.

To apply the proposed method, the BS may provide a set of weight factors to be applied per PO burst (or per another agreed interval) through NES-paging-para. The weight factor may be received by the UE through a higher layer signal (e.g. SIB or dedicated RRC signal) transmitted by the BS. The weight factor may be provided as a value that is provided as the same number as the number of POs provided in the PO burst and applied for each PO, or may be determined as a two-stage weight divided into a weight applied to overlapping POs and a weight applied to non-overlapping POs and determined to provide a value for all or a single ratio.

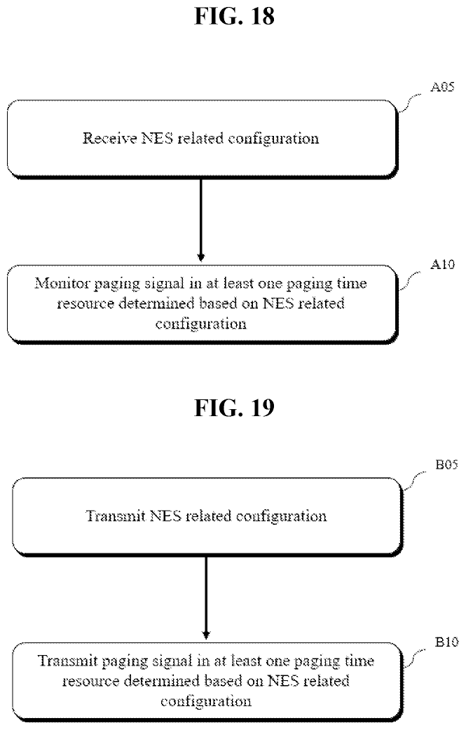

FIG. 18 is a diagram for explaining signal reception of a UE according to an embodiment.

Referring to FIG. 18, the UE may receive a network energy saving (NES) related configuration from a network (A05). The NES related configuration may include information about NES paging windows provided while an NES operation is performed.

The UE may monitor a paging signal in at least one paging time resource determined based on the NES related configuration from among a plurality of paging time resources related to paging discontinuous reception (DRX) (A10). While the NES operation is performed, the UE may perform monitoring of the paging signal based on a part of the paging time resources excluding paging time resources located outside the NES paging windows.

The information about the NES paging windows may include at least one of information about a period of the NES paging windows and information about a length of each NES paging window.

The information about the NES paging windows may include information about a pattern of the NES paging windows in the time domain.

From among the paging time resources included in the first NES paging window, monitoring of the paging signal may be performed on an Nth paging time resource, and from among the paging time resources included in the second NES paging window, monitoring of the paging signal may be performed on the Mth paging time resource, and N and M may be different integers.

The Nth paging time resource in the first NES paging window and the Mth paging time resource in the second NES paging window may be determined through a paging time resource hopping rule defined in the time domain.

The NES related configuration may include information about the paging time resource hopping rule.

The monitoring of the paging signal may be omitted on paging time resources between the first NES paging window and the second NES paging window.

The NES related configuration may be for an NES operation in a radio resource control (RRC) idle/inactive state.

Each paging time resource may be either a paging frame (PF) or a paging occasion (PO).

The paging signal may be a physical downlink control channel (PDCCH) with a cyclic redundancy check (CRC) scrambled with a paging-radio network temporary identifier (P-RNTI).

FIG. 19 is a diagram for explaining signal transmission of a BS according to an embodiment.

Referring to FIG. 19, the BS may transmit a network energy saving (NES) related configuration (B05). The NES related configuration may include information about NES paging windows provided while an NES operation is performed.

The BS may transmit a paging signal in at least one paging time resource determined based on the NES related configuration from among a plurality of paging time resources related to paging discontinuous reception (DRX) (B10). While the NES operation is performed, the BS may perform transmission of the paging signal based on a part of the paging time resources excluding paging time resources located outside the NES paging windows.

The information about the NES paging windows may include at least one of information about a period of the NES paging windows and information about a length of each NES paging window.

The information about the NES paging windows may include information about a pattern of the NES paging windows in the time domain.

From among the paging time resources included in the first NES paging window, transmission of the paging signal may be performed on an Nth paging time resource, and from among the paging time resources included in the second NES paging window, transmission of the paging signal may be performed on the Mth paging time resource, and N and M may be different integers.

The Nth paging time resource in the first NES paging window and the Mth paging time resource in the second NES paging window may be determined through a paging time resource hopping rule defined in the time domain.

The NES related configuration may include information about the paging time resource hopping rule.

The transmission of the paging signal may be omitted on paging time resources between the first NES paging window and the second NES paging window.

The NES related configuration may be for an NES operation in a radio resource control (RRC) idle/inactive state of the UE.

Each paging time resource may be either a paging frame (PF) or a paging occasion (PO).

The paging signal may be a physical downlink control channel (PDCCH) with a cyclic redundancy check (CRC) scrambled with a paging-radio network temporary identifier (P-RNTI).

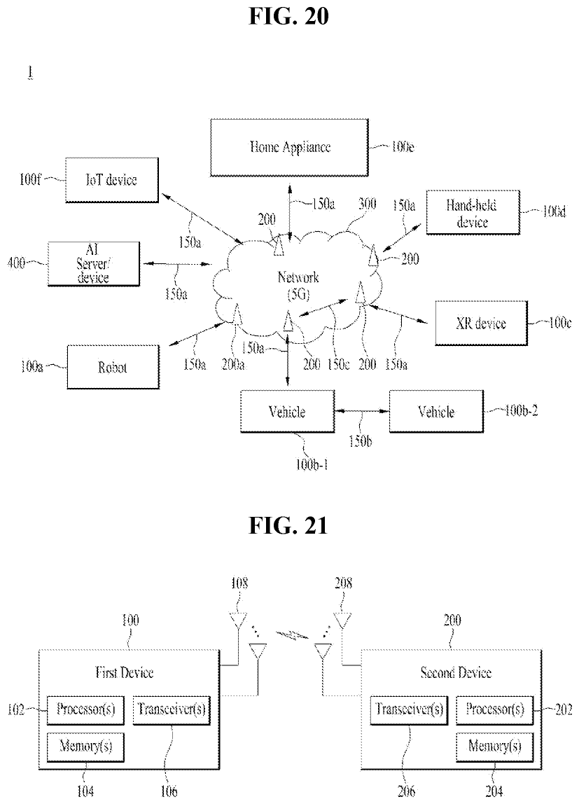

FIG. 20 illustrates a communication system 1 applied to the present disclosure.

Referring to FIG. 20, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. 21 illustrates wireless devices applicable to the present disclosure.

Referring to FIG. 21, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 20.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In an embodiment of the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In an embodiment of the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

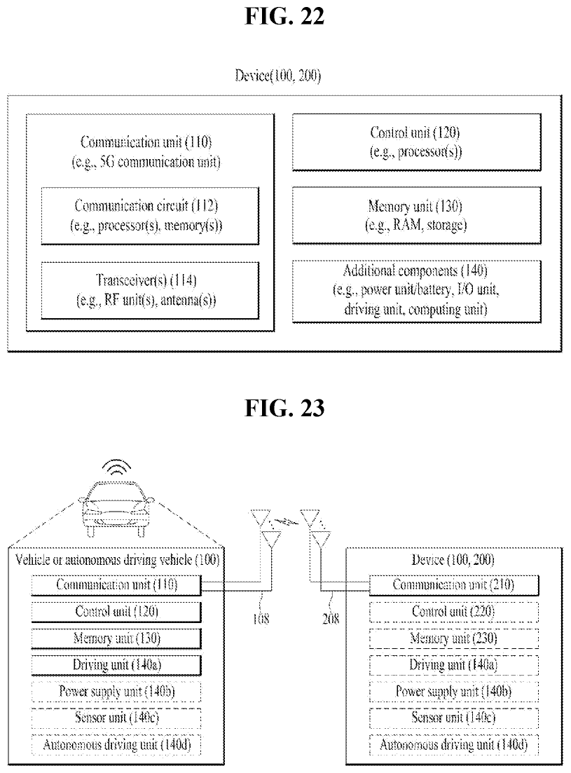

FIG. 22 illustrates another example of a wireless device applied to the present disclosure. The wireless device may be implemented in various forms according to a use-case/service (refer to FIG. 20).

Referring to FIG. 22, wireless devices 100 and 200 may correspond to the wireless devices 100 and 200 of FIG. 21 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 21. For example, the transceiver(s) 114 may include the one or more transceivers 106 and 206 and/or the one or more antennas 108 and 208 of FIG. 21. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 20), the vehicles (100b-1 and 100b-2 of FIG. 20), the XR device (100c of FIG. 20), the hand-held device (100d of FIG. 20), the home appliance (100e of FIG. 20), the IoT device (100f of FIG. 20), a digital broadcast terminal, a hologram device, a public safety device, an MTC device, a medicine device, a fintech device (or a finance device), a security device, a climate/environment device, the AI server/device (400 of FIG. 20), the BSs (200 of FIG. 20), a network node, etc. The wireless device may be used in a mobile or fixed place according to a use-example/service.

In FIG. 22, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

FIG. 23 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 23, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 22, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

The above-described embodiments correspond to combinations of elements and features of the present disclosure in prescribed forms. And, the respective elements or features may be considered as selective unless they are explicitly mentioned. Each of the elements or features may be implemented in a form failing to be combined with other elements or features. Moreover, it is able to implement an embodiment of the present disclosure by combining elements and/or features together in part. A sequence of operations explained for each embodiment of the present disclosure may be modified. Some configurations or features of an embodiment may be included in another embodiment or may be substituted for corresponding configurations or features of another embodiment. And, an embodiment may be configured by combining claims failing to have relation of explicit citation in the appended claims together or may be included as new claims by amendment after filing an application.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The present disclosure is applicable to UEs, BSs, or other apparatuses in a wireless mobile communication system.

1. A method performed by a user equipment (UE), the method comprising:
receiving a configuration from a network; and
monitoring a paging signal in at least one paging time resource determined based on the configuration from among a plurality of paging time resources for paging discontinuous reception (DRX),
wherein the configuration includes information about paging windows, and
wherein the UE performs the monitoring of the paging signal based on a part of the paging time resources excluding paging time resources located outside the paging windows.

2. The method of claim 1, wherein information about the paging windows includes at least one of information about a period of the paging windows or information about a length of each paging window.

3. The method of claim 1, wherein information about the paging windows includes information about a pattern of the paging windows in a time domain.

4. The method of claim 1,
wherein, from among the paging time resources provided in a first paging window, the monitoring of the paging signal is performed on an N^{th} paging time resource, and
wherein, from among the paging time resources provided in a second paging window, the monitoring of the paging signal is performed on an M^{th} paging time resource, N and M being different integers.

5. The method of claim 4, wherein the N^{th} paging time resource in the first paging window and the M^{th} paging time resource in the second paging window are determined through a paging time resource hopping rule defined in a time domain.

6. The method of claim 5, wherein the configuration includes information about the paging time resource hopping rule.

7. The method of claim 4, wherein the monitoring of the paging signal is omitted on paging time resources between the first paging window and the second paging window.

8. The method of claim 1, wherein the configuration is for a network energy saving (NES) operation in a radio resource control (RRC) idle/inactive state.

9. The method of claim 1,
wherein each paging time resource is either a paging frame (PF) or a paging occasion (PO), and
wherein the paging signal is a physical downlink control channel (PDCCH) with a cyclic redundancy check (CRC) scrambled with a paging-radio network temporary identifier (P-RNTI).

10. A non-transitory computer-readable recording medium having recorded thereon a program for performing the method of claim 1.

11. A device comprising:
a memory configured to store instructions; and
a processor configured to perform operations by executing the instructions;
wherein the operations of the processor include:
receiving a configuration from a network; and
monitoring a paging signal in at least one paging time resource determined based on the configuration from among a plurality of paging time resources for paging discontinuous reception (DRX),
wherein the configuration includes information about paging windows, and
wherein the monitoring of the paging signal is performed based on a part of the paging time resources excluding paging time resources located outside the paging windows.

12. The device of claim 11, further comprising a transceiver configured to transmit or receive a radio signal under control of the processor,
wherein the device is a user equipment (UE) operating in a wireless communication system.

13. The device of claim 11, wherein the device is a signal processing device configured to control a user equipment (UE) operating in a wireless communication system.

14. A method performed by a base station (BS), the method comprising:
transmitting a configuration; and
transmitting a paging signal in at least one paging time resource determined based on the configuration from among a plurality of paging time resources related to paging discontinuous reception (DRX),
wherein the configuration includes information about paging windows and
wherein the BS performs the transmitting of the paging signal based on a part of the paging time resources excluding paging time resources located outside the paging windows.

15. (canceled)
